(19) United States
(12) Patent Application Publication
(10) Pub. No.: US 2017/0255705 A1
(43) Pub. Date: Sep. 7, 2017

(54) METHOD AND APPARATUS OF BROWSING MODELING

(71) Applicant: Nokia Technologies Oy, Espoo (FI)

(72) Inventor: Guang YANG, San Jose, CA (US)

(21) Appl. No.: 15/583,352

(22) Filed: May 1, 2017

Related U.S. Application Data
(63) Continuation of application No. 12/508,924, filed on Jul. 24, 2009, now abandoned.

(51) Int. Cl. G06F 17/30

(52) U.S. Cl. CPC G06F 17/30899

(57) ABSTRACT

An approach is provided for modeling browsing. Data corresponding to navigation behavior relating to navigating a page of a browser application is collected. Storing of the data is initiated. An area within the page or another page of the browser application is predicted based on the stored data.

### RELATED APPLICATION

This application is a continuation of U.S. patent application Ser. No. 12/508,924, filed Jul. 24, 2009, entitled “METHOD AND APPARATUS OF BROWSING MODELING”, which is incorporated herein by reference in its entirety.

### BACKGROUND

Service providers and device manufacturers are continually challenged to deliver value and convenience to consumers by, for example, providing compelling network services and applications. One popular application involves browsing the World Wide Web. Currently browsing mechanisms can be inefficient with respect to how users navigate from web page to web page. At times, the user must traverse a number of pages to locate an area of interest. Also, these mechanisms are often not tailored to devices with constrained display sizes.

### SOME EXAMPLE EMBODIMENTS

According to one embodiment, a method comprises collecting data corresponding to navigation behavior relating to navigating a page of a browser application. The method also comprises initiating storing of the data. The method further comprises predicting, based on the stored data, an area within the page or another page of the browser application.

According to another embodiment, an apparatus comprising at least one processor, and at least one memory including computer program code, the at least one memory and the computer program code configured to, with the at least one processor, cause the apparatus to collect data corresponding to navigation behavior relating to navigating a page of a browser application. The apparatus is also caused to initiate storing of the data. The apparatus is further caused to predict, based on the stored data, an area within the page or another page of the browser application.

According to another embodiment, a computer-readable storage medium carrying one or more sequences of one or more instructions which, when executed by one or more processors, cause an apparatus to collect data corresponding to navigation behavior relating to navigating a page of a browser application. The apparatus is also caused to initiate storing of the data. The apparatus is further caused to predict, based on the stored data, an area within the page or another page of the browser application.

According to another embodiment, an apparatus comprises means for collecting data corresponding to navigation behavior relating to navigating a page of a browser application. The apparatus also comprises means for initiating storing of the data. The apparatus further comprises means for predicting, based on the stored data, an area within the page or another page of the browser application.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of modeling browsing of a user, according to one embodiment;

FIG. 2 is a diagram of the components of user equipment, according to one embodiment;

FIG. 3 is a flowchart of a process for modeling browsing of a user, according to one embodiment;

FIGS. 4A and 4C-4E are diagrams of user interfaces utilized in the processes of FIG. 3, according to various embodiments;

FIG. 4B is a state diagram used for modeling the browsing behavior of a user, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile station (e.g., handset) that can be used to implement an embodiment of the invention.

### DESCRIPTION OF SOME EMBODIMENTS

A method, apparatus, and software for modeling the browsing, and/or browsing behavior of a user are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

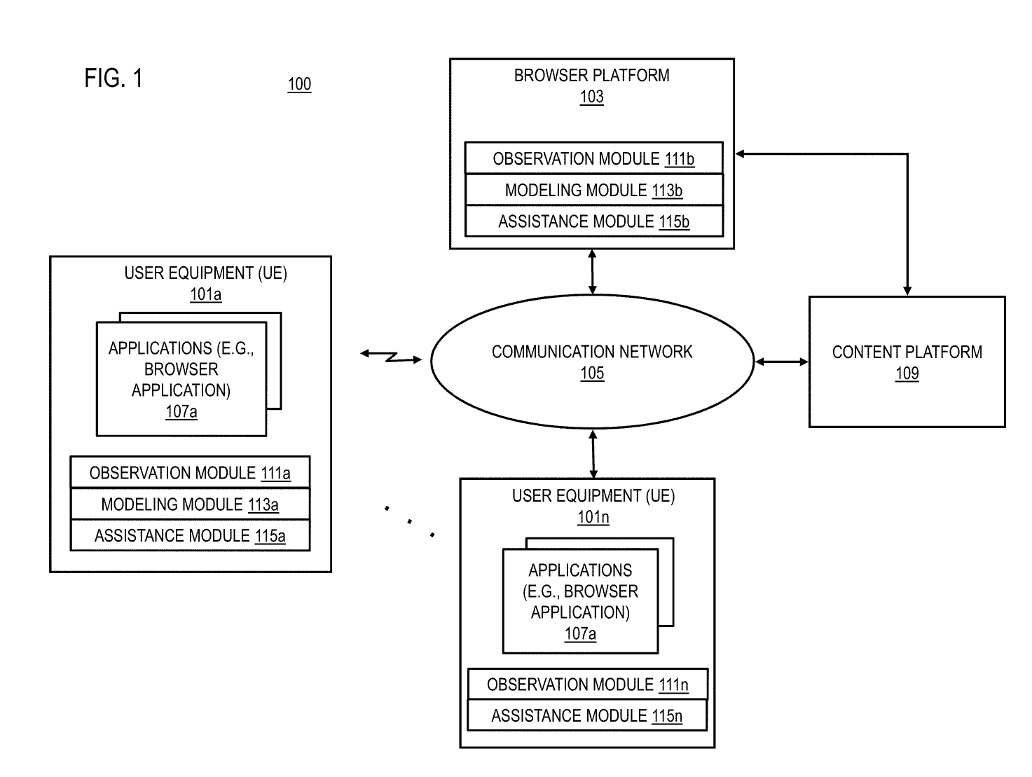

FIG. 1 is a diagram of a system capable of modeling browsing, and/or browsing behavior of a user, according to one embodiment. Browser applications (e.g., web browsers) are currently being used on various user equipments (UEs) 101, some of which may have limited screen resolution and space. Generally, web pages are designed for desktop and laptop computers with relatively large displays. As such, web page layouts are often complex with headers, footers, menus, navigation panels, advertisements, and multiple columns of content. The desired display resolution for these web pages is often 1024×768 or higher with an optimal screen size of 7 inches (for e.g., netbooks), 12 inches (for e.g., laptops), 17 inches (for e.g., desktop computers), or higher. Mobile devices typically run at lower resolutions with limited display dimensions because of form factor considerations and power constraints. Thus, users of these devices are required to pan or scroll, at times excessively, through the screen to locate the area the user wishes to view. This navigation can be difficult and cumbersome, for example when the mobile device does not have a touch screen or other user friendly interfaces; such is the case with mobile devices with limited functionalities (e.g., lower end models). It is also observed that web browsers, in general, are not personalized to help users navigate to the desired areas. For example, if two users visit the same link from the same model UE 101, each user will see the web page rendered in the same manner. Further, it is noted that a user who utilizes a device with limited screen space often has a clearer goal when visiting a website (e.g., to find certain information or to complete a certain task), as to endure the tediousness of the navigation controls. The reasons for visiting certain websites can vary from person to person (e.g., one user may read text when visiting a news site while another looks at the photos, one user may routinely log in to a banking website to check the user's balance, while another may check mortgage rates without logging in, etc.). It is further recognized that users often repeat the same sequence of navigational controls (e.g., scrolling and panning) on the same or similar websites before reaching the area or section of interest within the website.

Accordingly, system 100 of FIG. 1 introduces the capability to model browsing, and/or browsing behavior of the user, thereby assisting the user in efficiently browsing. Advantageously, the efficiency translates into reduced power consumption by minimizing the use of navigational controls, while enhancing user experience. In one embodiment, the system 100 collects browsing behavior information of a user utilizing a browser application on UE 101. Specifically, the collection can be performed by the UE 101 or a browser platform 103. According to one embodiment, behavior information can include the areas displayed on the UE 101, time stamps of when the user entered (i.e., moves a navigational control over a particular section) and left the areas, and/or other information about the content that the user is engaged in. The UE 101 or browser platform 103 can then create a model individualized to the user by processing the collected information. The model can be used to help assist the user in navigating a single web page, or a sequence of web pages.

Under the scenario of FIG. 1, the system 100 involves UEs 101a-101n having connectivity to the browser platform 103 via a communication network 105. The UE 101 can utilize a browser application 107a to obtain content from a content server 109 (e.g., web server). In one embodiment, the UE 101 connects to the content platform 109 through the communication network 105. The UE 101 can include an observation module 111a-111n, a modeling module 113a, or an assistance module 115a-n. In one embodiment, the UE 101 connects to the content platform 109 via the browser platform 103, which employs an observation module 111b, a modeling module 113b, and an assistance module 115b to aid a user with browsing.

In one embodiment, a UE 101n collects information about UE 101 browsing via an observation module 111a-n. Under this scenario, observations 111n are sent to the observation module 111b of the browser platform 103. For the purposes of illustration, the browser application 107 is explained with respect to accessing content on the World Wide Web over the global Internet; however, it is contemplated content can be resident on any data network (e.g., private networks, intranets, etc.). The browser platform 103 then records the observations, or user browsing behavior. In another embodiment, a UE 101n collects the information about a user's browsing behavior via an observation module 111a. The observation module 111 observes and records which web pages a user visits and how the user navigates the web pages. In one embodiment, the observation module 111 records which portion of the web page the user is viewing, along with timing information about when the user starts and finishes viewing of the particular areas of the web page. Moreover, the observation module 111 can also record such information across a variety of web pages within a single website, for example. In one embodiment, the portion of the web page that is displayed is known by the browser application (or a plugin of the application).

In another embodiment, a web page is associated with a Document Object Model (DOM) page structure, which is generated in the process of rendering the web page. In a client-side browser, the DOM is known to the UE 101. In a server-side browser (e.g., a browser where the rendering is completed on a browser platform 103 and then transferred to a UE 101 in a condensed format (e.g., a proprietary format)), the UE 101 communicates with the browser platform 103 and transmits what is being presented on the UE 101 display. The browser platform 103 can then convert the information back to a DOM format. Alternatively, the condensed format can be used throughout the observation, modeling, and assistance process in place of the DOM format. The DOM format is a tree structure of the elements (e.g., head, body, title, root html, etc.), attributes (e.g., href), and text of a document (e.g., an html document).

In one embodiment, the observation module 111 determines a page area that is associated with a page structure, and which is displayed on a browser window. In one embodiment, the observation module 111 determines the sub-tree of a DOM that is associated with the content displayed on a browser window. In this embodiment, the observation module 111 approximates a mapping of the browser window, as it is being used by a user, to a sub-tree in the DOM of a web page. In one embodiment, the smallest sub-tree in the DOM that covers at least a certain percentage (e.g., 50%) of the area in the browser window is selected for mapping. In another embodiment, the smallest sub-tree in the DOM that covers the entire area in the browser window is selected for mapping. In yet another embodiment, the largest sub-tree in the DOM that is completely within the browser window is selected for the mapping. If no sub-trees in the DOM meet the rule, the next closest sub-tree can be chosen or a separate rule can be applied. The DOM structure of the web page can be saved so it can be referred back to at a later time. In one embodiment, elements in the web page's DOM have unique identifiers that can be used to refer to the sub-tree. In another embodiment, a DOM sub-tree can be referred to by an index, an array, or a pointer.

According to one embodiment, the observation module 111 determines the start and finish times or duration of what the user is viewing on a web page. Notably, the browser can timestamp the start and stop times. The timestamps can be recorded in the International Organization for Standards (ISO) 8601 or any other appropriate format. In one embodiment, to accommodate for transitions from one viewing area to another viewing area of the web page, the starting timestamp is not recorded unless the web page has been in a stable state for a certain amount of time (e.g., 3 seconds). Thus, a starting timestamp may be recorded when the state of the web page is stable for a predetermined time period. The predetermined time period can be empirically tuned based on user observations. With the timestamp, an identifier to a DOM sub-tree that the user is looking at is also recorded. An ending timestamp can be recorded on the state when the user browses away from the DOM sub-tree. The state change can occur when the user scrolls or pans the page, clicks on a link, or performs another operation such that the content in the browser window (e.g., the sub-tree of the DOM, or the DOM itself) has changed. Alternatively, the observation module 111 gathers additional information (e.g., zoom level of the browser, font size used by the browser, etc.). In accordance with one embodiment, another object is used to identify a portion of a web page instead of a DOM tree.

As mentioned, either the UE 101a or the browser platform 103 can model the behavior of the UE 101a based on data collected by the observation module 111. A modeling module 113 generates the model to predict future behavior of a browser application 107 of the UE 101. The user behavior modeling can be executed on the UE 101 for client-side browsers and on a browser platform 103 for server-side browsers. The modeling can occur any place the observed and recorded states are available.

The modeling module 113 can create a model to predict the behavior of the user utilizing any number of modeling methods. In one embodiment, Markov Chains are used to determine the behavior of the user. A Markov Chain has three parts: a set of states, transition probabilities between states, and the initial probability distribution of states. The observation module 111 (e.g., DOM sub-trees) captures such state information. The modeling module 113 can remove states that appear less frequently to reduce the complexity of the model. Once the states are defined, transition probabilities are determined for the transition of one state to another state. Transition probabilities can be computed using timestamps associated with the states (e.g., if the average time spent in a state is t1, where t1 is greater than or equal to 1, the probability of staying in the state can be (t1−1)/t1, if a first state appears x times in total, among which for y times it transitions to a second state, then the transition probability for a transition from the first state to the second state is y/(x*t1)). Initial distribution probabilities can be calculated by determining the number of times a state acts as the entry point of the page(s) and then normalizing the probabilities to have a sum of one. The Markov Chain model can be updated when new observations become available. Updates can take place in real time, periodically, on demand, or when a threshold number of observations are made.

In one embodiment, the modeling module 113 is able to identify web pages that are structurally similar to share a single model. The modeling module 113 can predict the behavior of the user as the user visits new web pages rather than returning to older or prior pages. In one embodiment, the modeling module 113 captures the behavior of the user viewing a new web page by determining whether the current web page has a similar universal resource locator (URL) to a previously viewed web page. URLs are often organized in a hierarchical fashion, thus the longer the prefix (e.g., [rootwebsite]/date/news/world/index.html and [rootwebsite]/date/news/finance/index.html) that two URLs share, the more likely that they are generated from similar templates. Rules can be set up to define and determine how similar two URLs are. In another embodiment, the modeling module 113 determines the behavior of the user viewing the new web page by determining if the web pages have a similar DOM structure to a previously modeled web page. To determine that two web pages are structurally similar, the DOM of each web page are compared. In one embodiment, a Tree Edit Distance method is used to compare the DOMs. In one embodiment, if the distance between the two DOMs is not within the defined threshold, the two web pages can have separate models. Additionally, DOMs can be compared to determine whether a web page has changed its DOM template. If the DOM has changed significantly, the old model can be discarded and a new model can be determined. In another embodiment, a combination of the URL and DOM structure comparisons are used as a two step process. In this embodiment, the new web page's URL is filtered through URL similarities and then DOM structures between the new web page and old web pages with similar root URLs are compared.

According to one embodiment, the assistance module 115 provides browsing and navigation assistance to the user based on the user's browsing behavior. This approach is utilized when the user visits a web page, and a matching model is found (either in the client-side browser on the mobile device, or in the server-side browser on the server). In one embodiment, shortcuts are provided to the various parts of the web page that the user is more likely to visit. In one embodiment, the various parts are predicted from the user's browsing behavior in the past on similar web pages. In another embodiment, the user is automatically taken to a predicted part of the web page.

As shown in FIG. 1, the system 100 comprises UEs 101 having connectivity to a browser platform 103 and a content platform 109 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), audio/video player, digital camera/camcorder, positioning device, electronic book device, television, or any combination thereof. It is also contemplated that the UE 101 can support any type of interface to the user (such as “wearable” circuitry, etc.).

By way of example, the UE 101, browser platform 103, and content platform 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

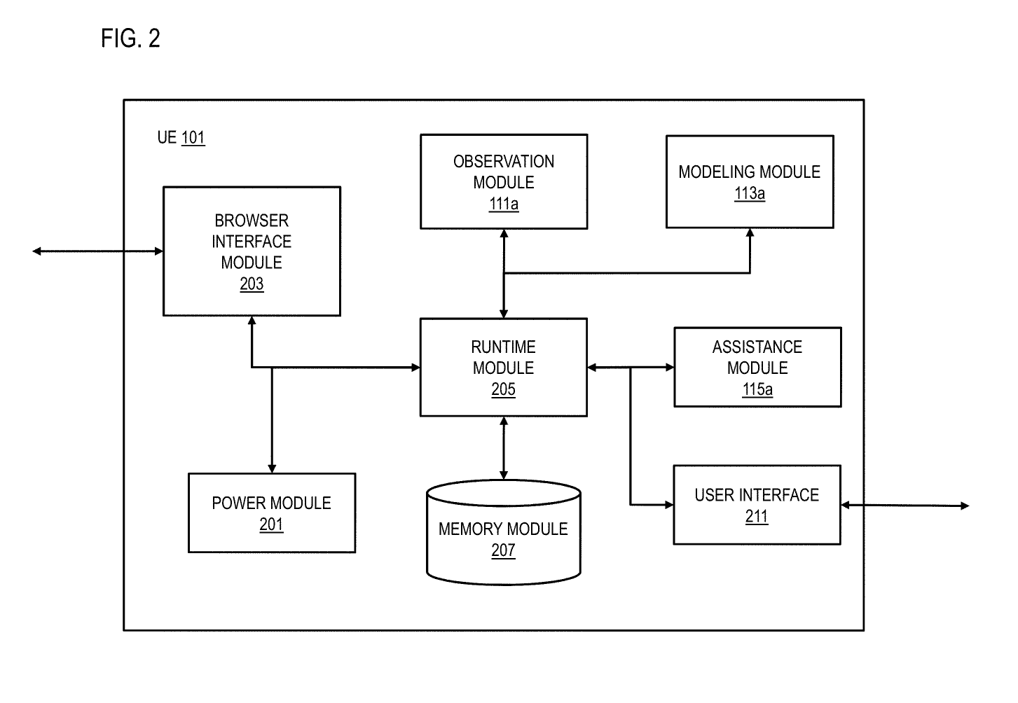

FIG. 2 is a diagram of the components of a user equipment 101, according to one embodiment. By way of example, the UE 101 includes one or more components for providing web page behavior data collection, modeling, and assistance. It is contemplated that the functions of these components may be combined in one or more components or performed by other components of equivalent functionality. In this embodiment, the UE 101 includes a power module 201, a browser interface module 203, a runtime module 205, a memory module 207, a user interface 209, an observation module 111a, a modeling module 113a, and an assistance module 115a.

The power module 201 provides power to the UE 101. The power module 201 can include any type of power source (e.g., battery, plug-in, etc.). Additionally, the power module can provide power to the components of the UE 101 including processors, memory, and transmitters.

In one embodiment, a UE 101 includes a browser interface module 203. The browser interface module 203 is used by the runtime module 205 to communicate with a browser platform 103 or a content platform 109. In some embodiments, the browser platform 103 is used to render web content being browsed by a browser on the UE 101. In other embodiments, the UE 101 renders the web content via a connection to a content platform 109 having the browsing content data.

In one embodiment, a UE 101 includes a user interface 209. The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, etc. Some lower-end UEs may have purely a button interface while middle-to-higher-end UEs can have a touch-screen interface or a combination of multiple inputs. A user can input a request to upload or receive object information via the user interface 209. In one embodiment, the user interface 209 displays a web browser. In this embodiment, the runtime module 205 receives a request from a user input and stores the request in the memory module 207. In one embodiment, the request is for browsing a web page. The observation module 111 collects information about the browsing behavior of the UE 101 and stores the information in the memory module 207. Then, the modeling module 113 generates a model based on the information. The user interface 209 then displays shortcuts to a user utilizing the assistance module 115.

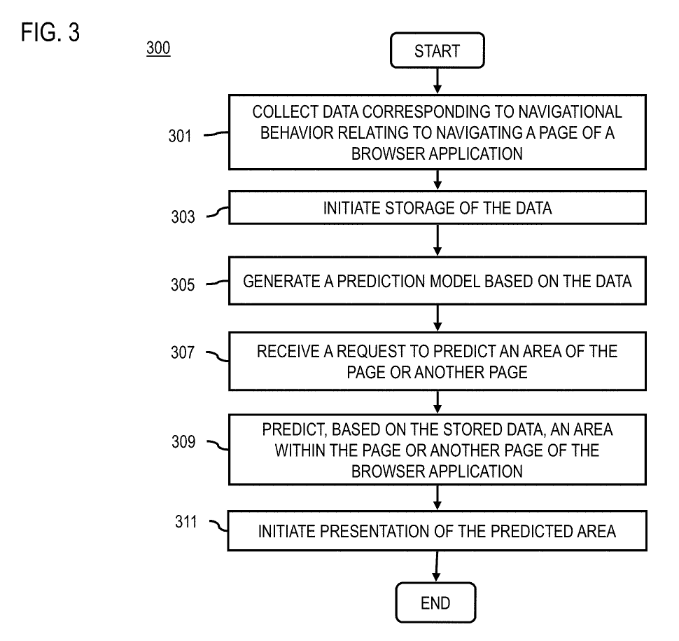

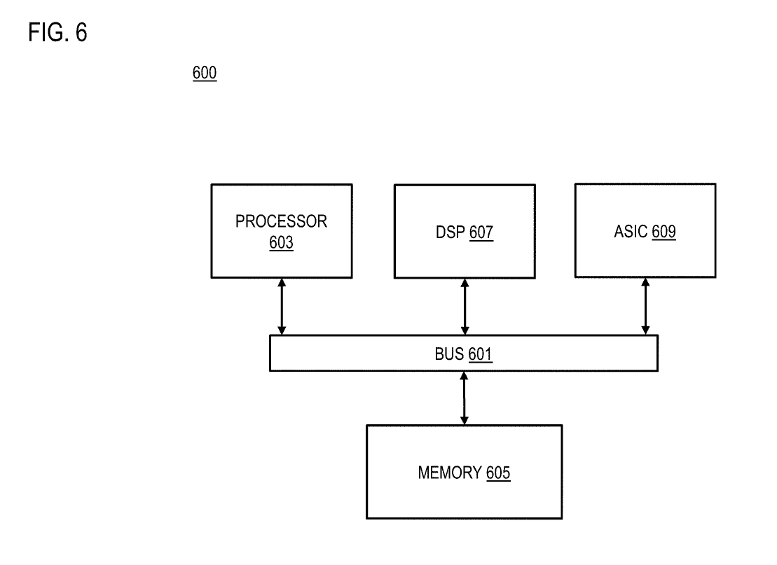

FIG. 3 is a flowchart of a process for modeling browsing, and/or browsing behavior of a user, according to one embodiment. In one embodiment, a UE 101 or a browser platform 103 performs the process 300 and is implemented in, for instance, a chip set including a processor and a memory as shown FIG. 6. In one embodiment, a user of a UE 101 begins using the UE 101 to navigate web pages. In step 301, a UE 101 collects data corresponding to navigational behavior relating to navigating a page of a browser application 107. The data can include page structure data (e.g., a DOM tree) corresponding to the layout of a page being displayed. In one embodiment, the page structure can be related to a Hypertext Markup Language (HTML) or Extensible Hypertext Markup Language (XHTML) web page. The data can also include a page viewing area data that correlates the area of the browser displayed on a user interface with the page structure data. In one embodiment, this is achieved by correlating the viewing area of the UE 101 with a DOM sub-tree based on certain rules. The data can also include timing data that corresponds to when the area within the page is displayed during navigation of the page. In one embodiment, the timing data can also include the duration of the length of time the area of the page is displayed during the navigation of the page. In another embodiment, the data includes zoom information of the browser or the font size of the viewing area of the browser.

In step 303, the UE 101 initiates storage of the data in a memory of the UE 101. In another embodiment, the browser platform 103 initiates storage of the data in a memory of the browser platform 103. The memory can be volatile (e.g., random access memory) or non-volatile (e.g., flash memory, hard drives, etc.).

At step 305, a predictive model is generated based on the data collected. In one embodiment, the predictive model utilizes Markov Chains. It is contemplated that other prediction models can be used. The prediction can be based on probabilities calculated from the timing data associated with the viewing times of areas being navigated. In some embodiments, the model is updated continuously, periodically, or when a predetermined threshold amount of data is collected. In one embodiment, the predetermined threshold amount of data can be when a certain capacity of information is collected. In another embodiment, the predetermined threshold amount of data can be based on a complete viewing session or a completed viewing of a tree object.

At step 307, the UE 101 receives a request to predict an area of the page or another page. The UE 101 then determines if the other page can use the predictive model created. A prediction model can be used for the other page if the page structure of the other page is similar to the page structure of the page or pages used to create the predictive model. In one embodiment, the decision to determine which predictive model to use can be based on URL prefix similarities. The longer the prefix that two web pages share, the more likely that the web pages were created using similar templates. In another embodiment, two web pages are structurally similar if the web pages have similar tree structures. In one embodiment, tree structures of two web pages can be compared by using a Tree Edit Distance. If the two pages are similar up to a certain similarity threshold, the same model can be used for prediction. Once a model is selected for prediction, at step 309, the model is executed to predict an area that a user would like to view based on historical navigational use by the user.

At step 311, the UE 101 or browser platform 103 initiates presenting of the predicted area. In one embodiment, the browser platform 103 creates a presentation based on the prediction model and initiates transmission of the presentation over a network to a UE 101. In another embodiment, the presentation is created on the UE 101 and the UE 101 initiates presentation to the user. In one embodiment, the user is displayed a predicted area of the web page when the user first turns to the page. In another embodiment, the user is displayed a set of shortcuts displaying the predicted areas to choose from. If the user determines that the wrong predictive model was used to create the presentation, the user can input a request to recalculate the predictive model based on different data and or prediction methods.

With the above approach, a user can more easily navigate content using a browser with a limited viewing area or an awkward, inefficient browsing navigation control. In this manner, a device collects data on the navigation habits of a user to predict what the user would like to see. The device then initiates presentation of the predicted areas. This can save battery life of a device by reducing the amount of time spent to get to desired content. The reduced time spent navigating translates to less power consumed by navigation controls, the screen, and/or radio circuitry of a mobile device, for instance.

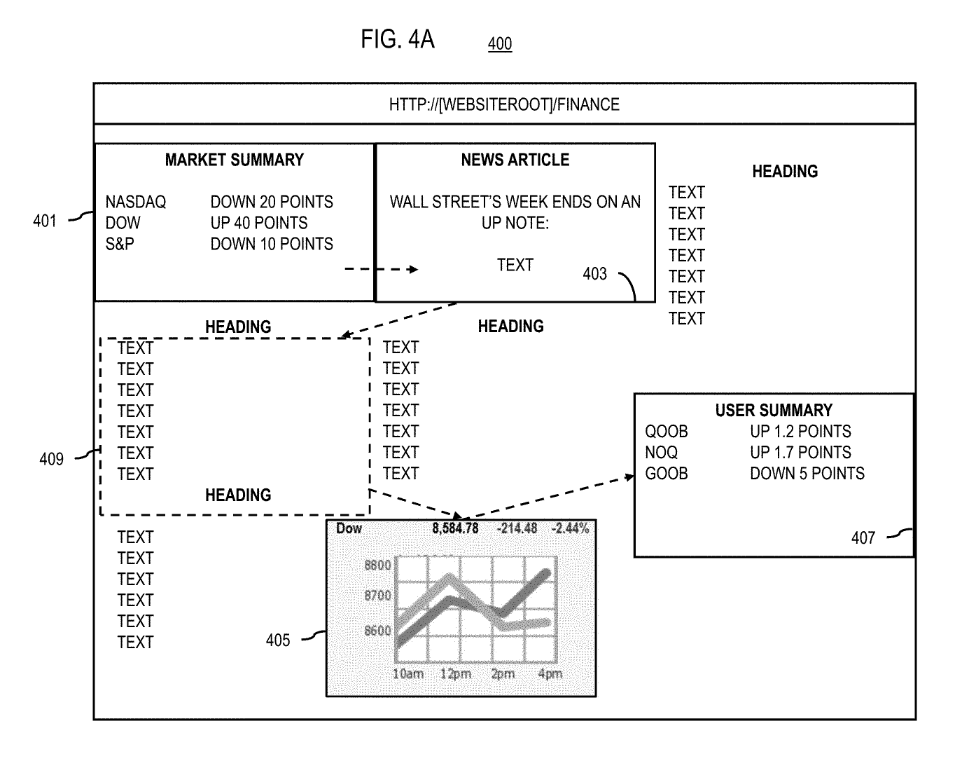

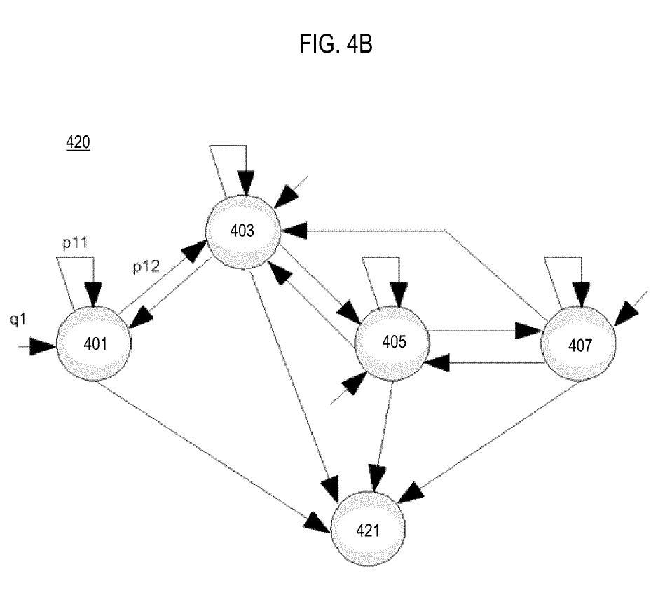

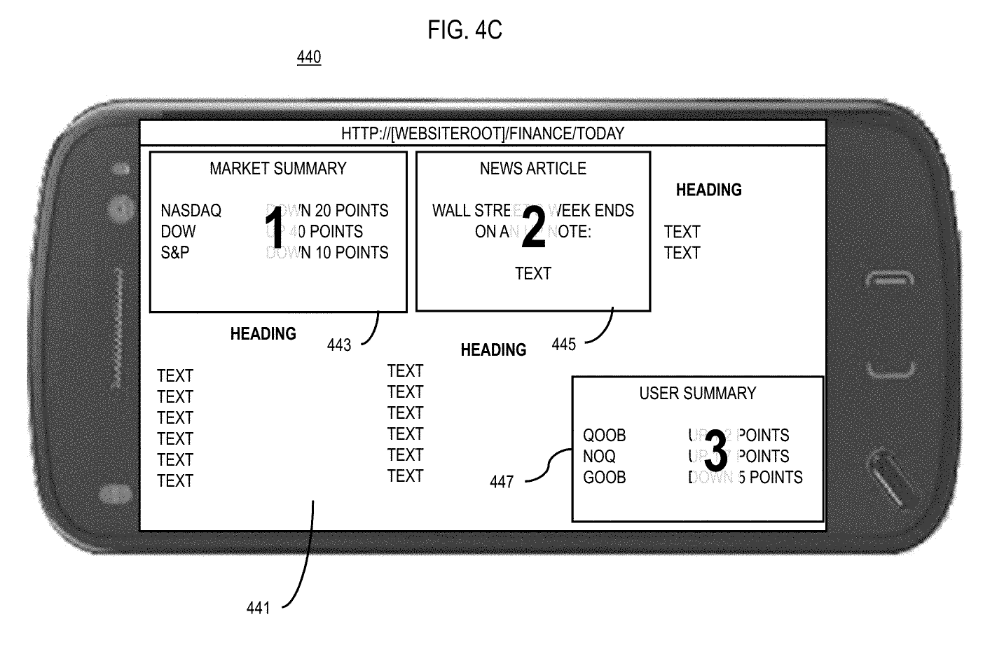

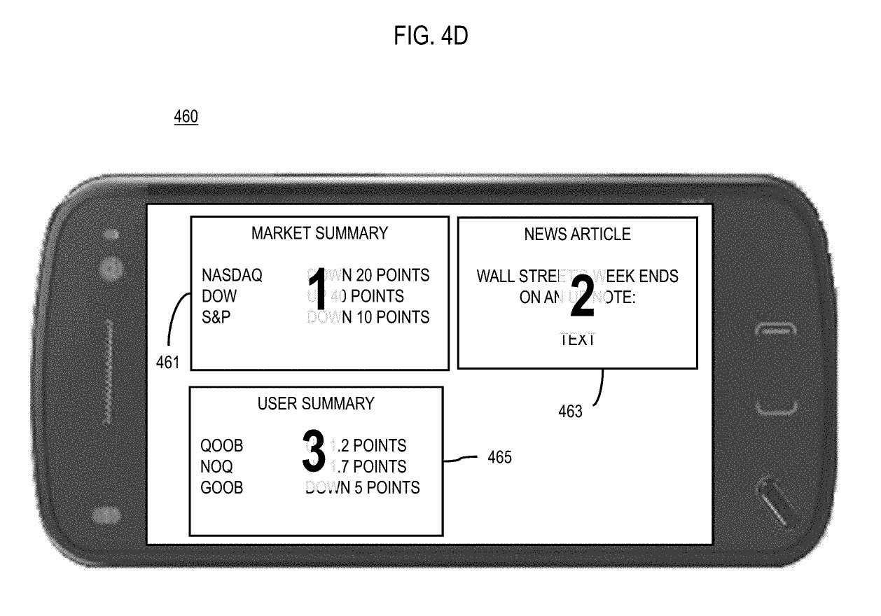

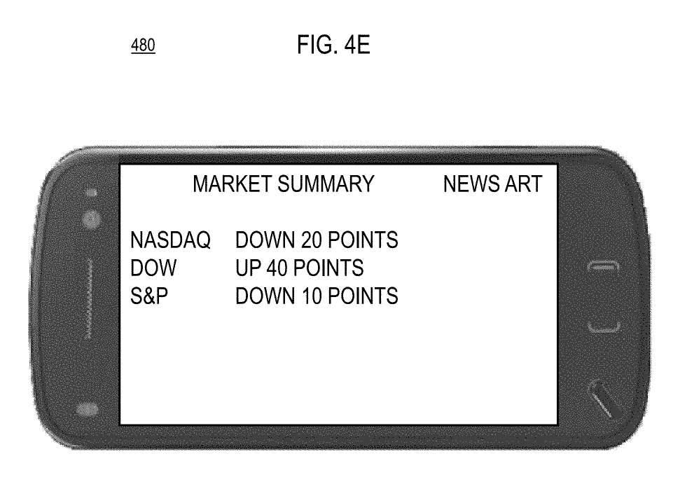

FIGS. 4A and 4C-4E are diagrams of user interfaces utilized in the processes of FIG. 3, according to various embodiments. FIG. 4A displays example user interface viewing areas 401, 403, 405, and 407, such as screen areas of the UI 101, of a web page 400. By way of example, the web page represents a financial news site. In this embodiment, the user begins viewing the web page at a market summary area 401, moves on to a news area 403, pans through a transition area 409 before stabilizing at a stock market chart area 405, and then ends the viewing at a user summary area 407 giving information about stocks that the user has recently looked up. An observation module 111 detects the movements (e.g., cursor control information, etc.) and collects timing information (e.g., start time, stop time, duration etc.) of each of the viewing areas 401, 403, 405, 407. In one embodiment, timing information may not be saved for the transition area 409 if the user does not remain within the area beyond a predetermined duration (i.e., the user did not stay at the transition area for a sufficient time period).

FIG. 4B shows a state diagram 420 used for modeling the browsing behavior of a user, according to one embodiment. The state diagram 420 can be used to generate a Markov Chain model to predict the areas of a web page the user would want to view. As noted previously, other state prediction models can be used. In this example, the states are the viewing areas 401, 403, 405, 407 of FIG. 4A. An exit state 421 is also defined to represent a case when the user leaves the page generating the model. Once the states are defined, transition probabilities (e.g., p11, p12) and initial state probabilities (e.g., q1) can be computed from timing data. In one embodiment, if the average time spent in a state (e.g., state 401) is t1, where t1 is greater than or equal to 1, then p11 (the probability that the state does not change) is equal to (t1−1)/t1. In another embodiment, if state 401 appears x times total, among which for y times it transitions to state 403, then the transition probability p12 is y/(x*t1). Initial distribution probabilities (e.g., q1) can be computed by determining the number of times a state acts as the entry point of the page; this number is then normalized. In one embodiment, the model is updated when new observations are made available. Alternatively, the model can be updated in real time, periodically, or when a sufficient number of new observations are collected.

FIG. 4C is a diagram of a user interface utilized in the processes of FIG. 3, according to one embodiments. In this embodiment, the user interface 440 displays a web page 441 that is related to a generated behavior model. In one embodiment, the web page 441 shares a similar web page structure to a web page or a set of web pages used to create the model. The user interface 440 displays a miniature view of the web page 441 with overlay shortcuts as rectangular boxes on top of the web page 441. FIG. 4D is a diagram of a user interface 460 that presents the shortcuts on a user interface 460 without the miniature view of the web page 441. By pressing (or otherwise selecting) a numeric key associated with the boxes 443, 445, 447, 461, 463, 465, the user is able to zoom into one of the boxes or switch between boxes. This navigational technique can be beneficial to user interfaces that do not provide convenient navigational capabilities. It is noted that other functions are available, e.g., a function leading back to the shortcuts display or a function dismissing the shortcut page and returning to unassisted browsing. In one scenario, the web page 441 does not have all of the features of the model web page. As such, the web page 441 does not show a shortcut to that viewing area or state (e.g., a chart). FIG. 4E is a diagram of a user interface 480 that displays a selected shortcut, according to one embodiment. In this example, the user can select other shortcuts by choosing a numeric key, browse shortcuts by selecting a next or previous button, or pan through the screen in a normal browsing fashion.

According to the above approach, a user can browse web pages with the assistance of a device. In this manner, the user's navigation habits are used to predict what the user would like to see. The device then initiates presentation of predicted areas of to view. This can save battery life on a mobile device by limiting the amount of time the user wastes viewing sections of web pages the user does not want to view.

The processes described herein for providing browsing behavior data collection, browsing behavior modeling, and browsing assistance may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

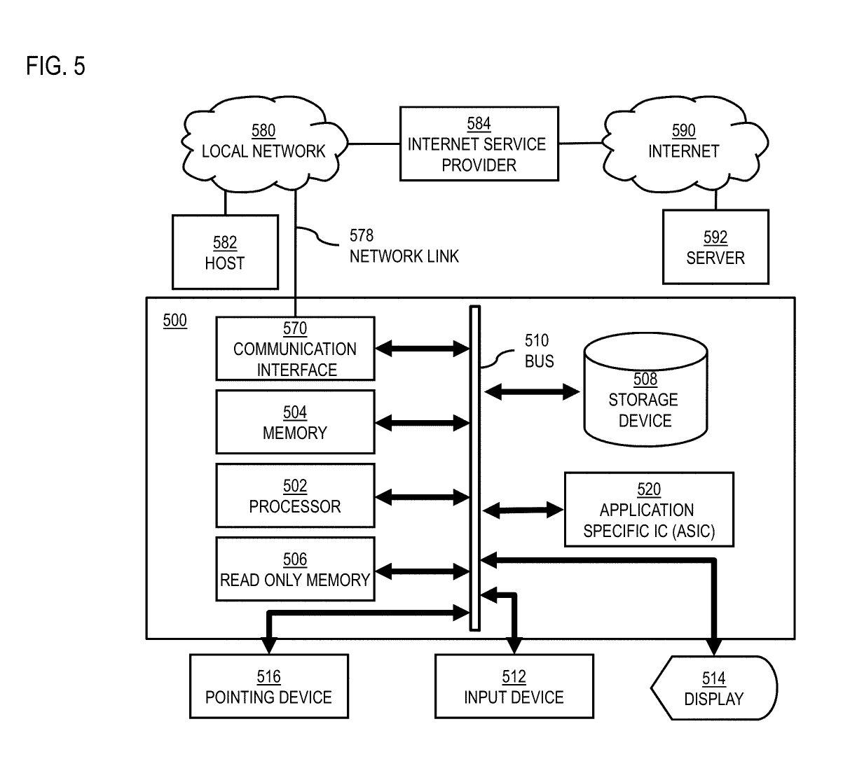

FIG. 5 illustrates a computer system 500 upon which an embodiment of the invention may be implemented. Computer system 500 is programmed (e.g., via computer program code or instructions) to provide browsing behavior data collection, browsing behavior modeling, and browsing assistance as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to provide browsing behavior data collection, browsing behavior modeling, and browsing assistance. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for providing browsing behavior data collection, browsing behavior modeling, and browsing assistance. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for providing browsing behavior data collection, browsing behavior modeling, and browsing assistance, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing browsing behavior data collection, browsing behavior modeling, and browsing assistance to the UE 101.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590. A computer called a server host 592 connected to the Internet hosts a process that provides a service in response to information received over the Internet. For example, server host 592 hosts a process that provides information representing video data for presentation at display 514.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set 600 upon which an embodiment of the invention may be implemented. Chip set 600 is programmed to provide browsing behavior data collection, browsing behavior modeling, and browsing assistance as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to browsing behavior data collection, browsing behavior modeling, and browsing assistance. The memory 605 also stores the data associated with or generated by the execution of the inventive steps.

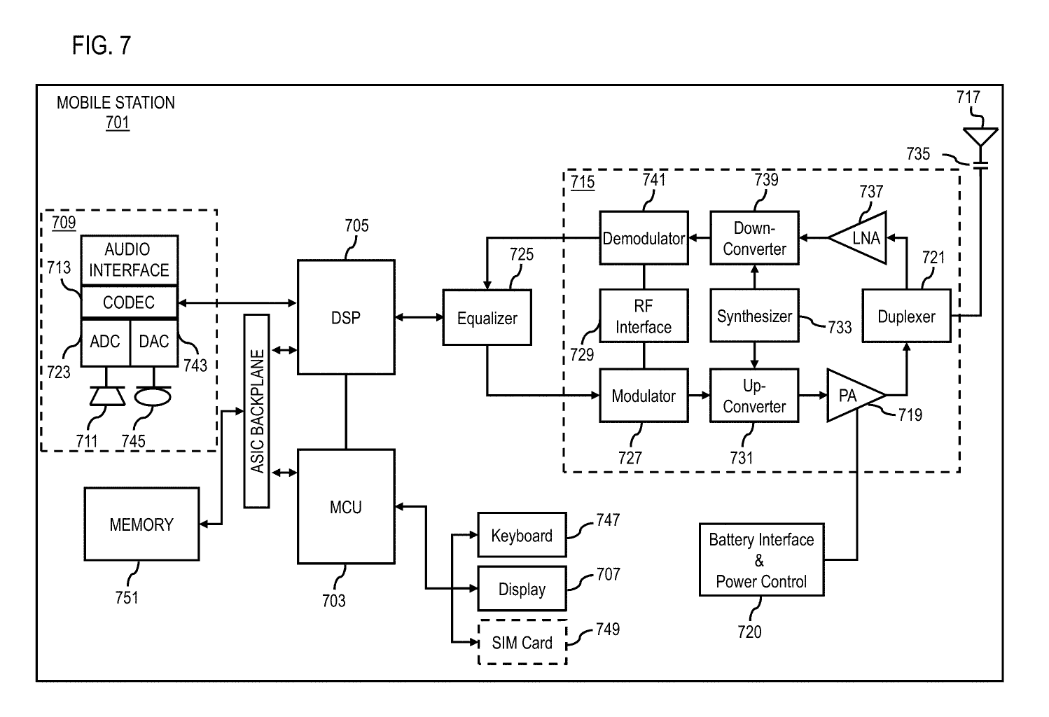

FIG. 7 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions that offer automatic contact matching. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile station 701 to provide browsing behavior data collection, browsing behavior modeling, and browsing assistance. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. (canceled)

2. A method comprising:
collecting data corresponding to navigation behaviors of a user when navigating a webpage via a browser application;
generating a model, based on the data, to predict subsequent webpage navigation behaviors of the user;
executing the model to predict areas within another webpage that has a page structure similar to a page structure of the webpage in a predetermined threshold; and
initiating a presentation on a user interface of shortcuts respectively overlaying onto the areas within the another webpage.

3. A method of claim 2, wherein the page structure includes: a page layout of viewing areas within the webpage with respect to content objects.

4. A method of claim 2, wherein the presentation shows the shortcuts on top of a miniature view of the another webpage.

5. A method of claim 2, wherein the areas are numbered based on a viewing order by the user, and the presentation arranges the shortcuts as numbered on the user interface without displaying the another webpage or a miniature view of the another webpage.

6. A method of claim 5, further comprising:
initiating another presentation on the user interface that zooms in one of the areas, upon a user selection of one of the shortcuts corresponding to the one area.

7. A method of claim 5, further comprising:
initiating another presentation of one of the areas on the user interface, upon a user selection of another one of the areas.

8. A method of claim 2, wherein the page structure corresponds to a document object model format, and the data includes timing data corresponding to when the areas within the webpage are displayed during the navigating and time periods of viewing the areas are displayed.

9. An apparatus comprising:
at least one processor; and
at least one memory including computer program code for one or more programs,
the at least one memory and the computer program code configured to, with the at least one processor, cause the apparatus embedded in a device to perform at least the following,
collect data corresponding to navigation behaviors of a user when navigating a webpage via a browser application;
generate a model, based on the data, to predict subsequent webpage navigation behaviors of the user;
execute the model to predict areas within another webpage that has a page structure similar to a page structure of the webpage in a predetermined threshold; and
initiate a presentation on a user interface of shortcuts respectively overlaying onto the areas within the another webpage.

10. An apparatus of claim 9, wherein the page structure includes: a page layout of viewing areas within the webpage with respect to content objects.

11. An apparatus of claim 9, wherein the presentation shows the shortcuts on top of a miniature view of the another webpage.

12. An apparatus of claim 9, wherein the areas are numbered based on a viewing order by the user, and the presentation arranges the shortcuts as numbered on the user interface without displaying the another webpage or a miniature view of the another webpage.

13. An apparatus of claim 12, wherein the apparatus is further caused to:
initiate another presentation on the user interface that zooms in one of the areas, upon a user selection of one of the shortcuts corresponding to the one area.

14. An apparatus of claim 12, wherein the apparatus is further caused to:
initiate another presentation of one of the areas on the user interface, upon a user selection of another one of the areas.

15. An apparatus of claim 9, wherein the page structure corresponds to a document object model format, and the data includes timing data corresponding to when the areas within the webpage are displayed during the navigating and time periods of viewing the areas are displayed.

16. A non-transitory computer-readable storage medium carrying one or more sequences of one or more instructions which, when executed by one or more processors, cause an apparatus embedded in a device to at least perform the following steps:
collecting data corresponding to navigation behaviors of a user when navigating a webpage via a browser application;
generating a model, based on the data, to predict subsequent webpage navigation behaviors of the user;
executing the model to predict areas within another webpage that has a page structure similar to a page structure of the webpage in a predetermined threshold; and
initiating a presentation on a user interface of shortcuts respectively overlaying onto the areas within the another webpage.

17. A non-transitory computer-readable storage medium of claim 16, wherein the page structure includes: a page layout of viewing areas within the webpage with respect to content objects.

18. A non-transitory computer-readable storage medium of claim 16, wherein the presentation shows the shortcuts on top of a miniature view of the another webpage.

19. A non-transitory computer-readable storage medium of claim 16, wherein the areas are numbered based on a viewing order by the user, and the presentation arranges the shortcuts as numbered on the user interface without displaying the another webpage or a miniature view of the another webpage.

20. A non-transitory computer-readable storage medium of claim 19, wherein the apparatus is caused to further perform:
initiating another presentation on the user interface that zooms in one of the areas, upon a user selection of one of the shortcuts corresponding to the one area.

21. A non-transitory computer-readable storage medium of claim 19, wherein the apparatus is caused to further perform:
initiating another presentation of one of the areas on the user interface, upon a user selection of another one of the areas.
